(19) United States
(12) Patent Application Publication
(10) Pub. No.: US 2011/0042028 A1
(43) Pub. Date: Feb. 24, 2011

(54) BINDER COMPOSITION AMD METHOD OF FORMING FOUNDRY SAND CORES AND MOLDS

(76) Inventors: Abraham Velasco-Tellez, Nuevo Leon (MX); Salvador Valtierra-Gallardo, Coahuila (MX); Gilberto Garcia-Tapia, Coahuila (MX); Alberto Esquivel-Herrera, Coahuila (MX); Satish Jhaveri, Oakville (CA)

Correspondence Address: FROMMER LAWRENCE & HAUG, 745 FIFTH AVENUE- 10TH FL., NEW YORK, NY, 10151, US

(21) Appl. No.: 12/440,553

(22) PCT Filed: Sep. 10, 2007
(86) PCT No.: PCT/IB07/04242

§ 371 Date: Jan. 5, 2010

(30) Foreign Application Priority Data
Sep. 8, 2006 (US) 11517995

(51) Int. Cl. B22C 9/02; C08L 3/00

(52) U.S. Cl. 164/21; 164/20; 106/38.51

(57) ABSTRACT

A cost-effective starch/water-based binder composition and related method for forming silica sand cores and molds for foundries, wherein the sand grains are pre-coated with starch having additives making the coated sand effective for blowing said cores and molds. One or more additives are included with the starch; preferably sodium tripolyphosphate and -silicon or Silres BS16. The preferred starch is a tapioca starch. The binder of the invention is highly competitive due to its low cost and effectiveness for forming silica-sand cores and molds, being particularly effective for use in aluminum foundries for the automotive industry.

### FIELD OF THE INVENTION

The present invention relates to binders and methods of forming foundry sand cores and molds made therefrom, and more particularly to water-based binders and methods of forming sand cores and molds with great economic and environmental advantages over the currently used organic-compound binders.

### BACKGROUND OF THE INVENTION

The automotive industry is extremely competitive and demanding regarding manufacturing costs of automobile components. The manufacturers of cylinder engine blocks and heads, mainly made of aluminum alloys, are constantly looking for methods and systems that provide cost savings and simultaneously increase the quality of such engine parts.

One of the preferred processes for manufacturing engine blocks and heads utilizes silica sand molds and cores. Currently, the molds and cores are most typically made of silica sand grains bound by a heat-curable phenolic binder or a gas activated cold box binder. The heat-curable binders have the disadvantage of requiring heat to set the molds and cores, producing foul-smelling vapors, and requiring special anti-pollution equipment to prevent ambient contamination. Another disadvantage arises once the cast motor blocks or heads are solidified, since removal of such cores and molds needs additional heat to burn off the binder by contact with hot air (in order to combust the binder and thus loosen the sand to destroy the cores), thus adding further to the fuel cost of the process.

There is a long-felt and ongoing need for a low-cost, energy efficient, and effective water-soluble binder for the molds and cores, particularly useful in the aluminum-alloys foundries, in order to decrease operational costs in the manufacture of engine blocks and heads.

Several early attempts to meet this need, going back many years, are mentioned below.

U.S. Pat. No. 2,508,359 discloses a starch-derived product for use as a core binder, and more particularly to such a binder made from dextrinized corn flour. No mention is made of any additives to improve flowability or for any other purpose.

U.S. Pat. No. 5,582,231 discloses a foundry mold member made from a plurality of sand particles bound together with a binder which consists essentially of gelatins (animal protein). The sand particles are coated with a film of a binder of gelatin having Bloom ratings of less than about 175 Bloom grams.

While a number of earlier patents teach the utilization of starch as a minor ingredient of water-soluble binders in different proportions for forming sand cores, the starch in such patents is used combined with the binder ingredient, such as alkaline silicates and organic resins, which provides the main binding effect and with which the starch cooperates. No reference has been found that addresses the problem of using starch in any form as the main binding constituent of a binder composition, while achieving good flow characteristics; so that the resulting starch-sand mix can be effectively air-blown into core forming boxes.

The present invention provides a starch-based binder composition employable in the widely-used core forming process of blow boxes where it is desired to have a low cost, environmentally friendly, and strong setting sand binding agent that at the same time forms with sand a mix that easily flows into the core molds and fills all the spaces in the geometries of even complex sand molds, such as for automotive parts. The binder composition of the present invention comprises one or more specific additives which, when mixed with starch and sand, yield a composition-sand mix especially suited for such core making process.

The following patents are of general background interest, which are not directly related with the invention.

U.S. Pat. No. 4,070,196 “Binder compositions” discloses a binder composition consisting essentially of an aqueous solution of an alkali metal silicate and a stabilized starch hydrolysate having a dextrose equivalent of below 5. The components being present in the weight ratios, calculated as solids, of 0.4 to 35 parts of stabilized starch hydrolysate per 20 to 49.5 parts alkali metal silicate. The mixture is hardened either by gassing with carbon dioxide or by incorporating chemical hardening agents such as esters of polyhydric alcohols.

U.S. Pat. No. 4,158,574 “Hydrolyzed amylaceous product and process of making same” relates to a foundry binder system employing glyoxal, a polyhydroxyl compound and a unique catalyst comprised of inorganic alkali halides. The polyols used are those that react rigidly with glyoxal including sugars, starch, starch hydrolysates, gums and dextrins. The general object of the invention is to make it possible for glyoxal to be used as a low-cost resin-forming binder system with control over the rate of setting.

U.S. Pat. No. 3,642,503 “Process for bonding particulate materials” teaches the use of an aqueous alkali metal silicate, silicon, dicalcium silicate and lime. An organic additive may be added to retard the setting of the binder, for example glucose or dextrose. No starch is mentioned.

Documents cited in this text (including the foregoing patents), and all documents cited or referenced in the documents cited in this text, are incorporated herein by reference. Documents incorporated by reference into this text or any teachings therein may be used in the practice of this invention.

The following description will largely be discussed in terms of the invention as applicable to sand cores, but it is to be understood to be equally applicable to sand molds (unless otherwise indicated from the context).

Applicants have found suitable additives for providing starch-based binders that combined with sand yield a mix with sufficient fluidity to be used with the standard method of blowing sand cores while at the same time obtaining cores of sufficient strength, shape definition, and shelf life (by combination of such additives in a predefined proportions) thus providing a suitable core and mold making process at a competitive cost.

### OBJECTS AND SUMMARY OF THE INVENTION

It is therefore an object of the present invention to provide competitively effective water-soluble binder compositions, binder-sand mixes made therefrom, and methods of making and using the same for forming sand cores and molds for foundries with several cost and technical advantages plus environmental benefits, as well as the cores and molds made with such compositions.

It is another object of the present invention to provide such methods of forming sand cores and molds for foundries at a lower cost.

It is a further object of the invention to provide such binder compositions for forming sand cores and molds for foundries the use of which do not require enclosed installations for control of foul smelling vapors in foundries.

It is still a further object of the invention to provide methods, binder compositions, binder sand mixes, and sand cores and molds for foundries for producing castings with dimensional precision that advantageously avoids the need to use higher-cost zircon sand to obtain comparable results.

It is yet a further object of the invention to achieve all the foregoing objectives using a starch-based binder and its starch derivatives (dextrines for example) that is demonstratively more effective than any starch-containing binder taught in the prior art.

The objects of the invention are generally met according to one aspect of the present invention by a binder made from starch having one or more additives to improve flowability, mechanical strength, water repellency, and, optionally as needed, the coating of the sand by the other additives by use of wetting agents.

Applicants have determined that the mix of sand with essentially any kind of starch can be used to make sand cores for at least some limited foundry purposes. Even insoluble amylopectin can be used when a proper temperature is applied. The resulting sand mix can be dumped into any core box with most any geometry and compacted to make the desired cores. However, using starch as the primary binder to the best of applicants' knowledge has never proven to be commercially useful (if ever commercially used at all), at least not by modern high volume production standards.

Note that a sand binder mix, made according to the present invention, is also applicable to the use of other types of sands besides the normal silica sand; such as zirconium sand, olivine sand, synthetic sand, and chromite sand. These other sands usually have a higher cost but some in certain markets, especially olivine sand in Europe, are less costly; and in certain other circumstances can provide better properties to the cores and are used for some special foundry applications.

However, to be commercially and competitively useful, a sand binder mix must be able to be blown into, and thereby be compacted in, the mold forms. In practice, the coated sand typically is pushed through blow pipes of about 1 inch or less in diameter, using air pressure. The applicants have surprisingly been able to achieve the goal of using low cost water soluble starch as a core binder, capable of being effectively blown, by use of one or more selective additives.

Such additives that have been found to effectively increase flowability are: sodium tripolyphosphate, sodium hexamethaphosphate, dicalcium phosphate dihydrate, sodium chloride, dimethylpolysiloxane and ethylic alcohol. All these additives work very well with the water repellency additives described below.

The following additives, that have been found to effectively control water repellency in the formed cores, are:

Alkyl silicone (Silres BS69050), triethoxy (2,4,4 trimethylpentyl) silane, octyl triethoxy silane plus alkyl silicone Silres BS16, wax emulsions, paraffin waxes, wax polymers, natural and paraffin wax combinations under different trade names were tested with acceptable results. The use of such water repellent additives serves to improve the shelf life of the formed starch based sand cores by preserving their mechanical strength (while awaiting use after being formed).

Of these, the water repellent additives that have been found to be particularly useful in this invention are: triethoxy (2,4,4 trimethylpentyl) silane, octyl triethoxy silane plus alkyl silicone and alkyl silicone (Silres BS69050 and Silres BS Powder A).

The additives that have been found to effectively contribute to providing sand cores using a starch binder with suitable mechanical strength, so that small dimensioned parts of said cores do not break during handling or metal pouring of the molds, are sodium tripolyphosphate, sodium hexamethaphosphate, and alkyl silicone (present in the “Silres” products).

In addition, the applicants have determined that some starches are better than others when used in commercial applications. As part of their ongoing research, applicants have found that tapioca starch to be superior to corn and potato starch with regard to the amount needed to achieve the same mechanical strength in the core.

The amylose/amylopectin ratio for tapioca is given as 0.22. Although the amylose is a linear chain of 500 to 2000 glucose units, the amylopectin is more massive and branched with linear chain lengths of 25-30 glucose units

Preferred embodiments of a binder composition according to the present invention comprise about 70%-95% starch (or more preferably 70%-90%, or still more preferably 70%-85%) plus additive(s) (such as, for example, preferably sodium tripolyphosphate and silicon or Silres BS16, or their functional equivalents).

Silres BS16, Silres BS Powder A, and Silres BS69050 are the tradenames of Wacker Chemie, AG. For example, Silres BS16 is a concentrated water solution of 1-5% potassium hydroxide and 40-70% potassium methyl siliconate (per the list of ingredients in that company's Material Safety Data Sheet for the U.S.); more specifically, that company's product brochure for Silres BS16 gives the solids content as 54 wt. % and the approximate active ingredients as 34%. Similarly, Silres BS Powder A is identified in the Wacker Chemie, AG literature as being a white powder consisting of approximately 50% (within a 30-60 wt. % range) of octyl triethoxy silane as the active ingredient and of ethanol.

A preferred method for making foundry sand cores with a binder-coated sand according to the present invention comprises mixing sand with starch in a proportion of about 0.5% to about 3% based on the weight of sand; adding an additive selected from the group of sodium tripolyphosphate, sodium hexamethaphosphate, dicalcium phosphate dihydrate and an alkyl silicone, triethoxy (2,4,4 trimethylpentyl) silane, octyl triethoxy silane, and an alcohol in a proportion not exceeding about 1% of the sand weight; then adding water in a proportion of about 5% to 15% of the sand weight; then adding more sand in a proportion from about 50% to 300% based on the initial weight of sand to achieve effective flowability of the resultant mass; blowing the binder-coated sand into the core mold; and extracting the formed core from said core box. The alcohols used in these processes re prefereably methanol, ethanol, or propanol, because they are typically the least expensive, with enthanol giving the better results.

An alternative earlier preferred embodiment of the present invention comprises mixing silica sand grains with starch in a suitable mixer, adding water to said sand and starch mixture and continue mixing said sand, starch, and water so that the sand grains are coated with starch (typically in about one minute); drying the starch-coated sand grains and treating them in a mill to break down lumps which might have been formed during the starch-coating step and screening the sand to separate said lumps; adding water to said coated sand grains and screening said sand grains for homogenizing and loosening said grains; adding sodium tripolyphosphate and silicon or Silres® BS16; optionally adding dispersing additives; and blowing said cores and molds utilizing said starch-coated sand grains.

This gives particularly good results, but requires more handling, and energy, thus being somewhat more costly.

Alternatively, as described in more detail below, applicants have determined that such starch binder coated sand can also be made by direct simultaneous mixing of sand, a starch binder and additives that can still be effectively blown.

The objects of the invention are also met by providing a sand core or mold made with the starch/water based binder composition of the present invention.

### BRIEF DESCRIPTION OF THE DRAWINGS

FIG. 1 shows a process block diagram illustrating a method according to one preferred embodiment of the invention for the manufacture of sand molds and cores using a starch binder.

FIG. 2 shows a process block diagram illustrating a method according to a different preferred embodiment of the invention for the manufacture of sand molds and cores using a starch binder.

FIG. 3 shows a process block diagram illustrating a method according to a further preferred embodiment of the invention for the manufacture of improved sand molds and cores well adapted to utilizing an artificially-modified tapioca type starch.

FIG. 4 shows a process block diagram illustrating a method according to a preferred embodiment similar to that shown in FIG. 3, modified to utilize a native tapioca type starch.

### DETAILED DESCRIPTION OF PREFERRED EMBODIMENTS

The present invention will be better understood with reference to the following detailed description of certain non-limiting specific embodiments thereof.

Sand cores are made from sand grains bound by a suitable binder which provides a strong bond between such sand grains in such a manner and with a sufficiency to withstand the handling of the cores and the assembled molds without losing the precise dimensions and form needed for impressing the desired geometry and surface quality to the casting under the temperature and pressure of the molten metal used to form said casting.

Currently, sand cores are shaped by mixing sand and a binder, blowing the binder-sand mixture into a mold having the desired shape, and curing or hardening the binder in the mold so that the mold geometry is fixed in the cores after their removal from said mold.

There are a variety of synthetic resins used as binders as is well known in the art. According to the present invention, a water-based binder and a method for forming the sand cores provide a number of advantages over the current state-of-the-art binders regarding manufacturing costs and core qualities.

The binder of the invention is mainly composed of starch as the ingredient (i.e well over 50%). Though starch has been utilized as an additive to prior-art binders, mostly in proportions of less than 20% of the binder composition, to the best of applicants' knowledge it has not previously been effectively used as the main constituent of a sand core-making binder in mass production foundries.

According to one preferred embodiment of the present invention, at least two additives are added to the starch, in the proportions and in the form explained below, which in combination with the starch, provide the necessary handling characteristics for use in mass production as well as the desired qualities to the formed cores. These additives in this embodiment are sodium tripolyphosphate and silicon or Silres BS16. Both serve to improve the mechanical strength of the core. The sodium tripolyphosphate serves the function of improving flowability, while the silicon or Silres BS16 serves the function of controlling water repellency. More broadly, the separate functions of the two additives with certain starches may be found in only one single additive.

There are several types of starch suitable to be utilized as the basis of the binder composition of the invention. One difference among them is the amount of starch needed to achieve the same mechanical strength. For example potato requires more than 2% weight (based on sand) and for maize close to 2% weight. However, when using Tapioca starch, the core needs significantly less starch content to achieve the same strength.

Tapioca starch is thus preferably used but other varieties of starch can also be utilized according to broader aspects of the invention. There are two types of tapioca starch: (a) native (i.e. unmodified) starch and (b) artificially-modified starch. Both types have proven effective as binders for the particular application of core making. The method of the invention may have some differences depending on which type of tapioca starch is utilized.

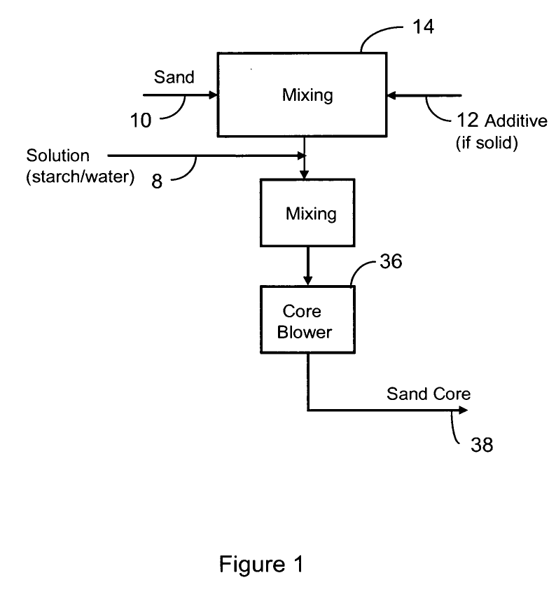

The core-making method of this embodiment of the invention will be described first as applied to the utilization of artificially-modified tapioca starch. With reference to FIG. 1, sand 10 is mixed with at least one additive 12 from a group consisting of sodium tripolyphosphate, sodium hexamethaphosphate, dicalcium phosphate dihydrate and an alkyl silicone, triethoxy (2,4,4 trimethylpentyl) silane, octyl triethoxy silane, and an alcohol, in a proportion between 0.1% and 0.5% of the sand weight for enough time to achieve homogenization of the mixture (typically approximately 15 to 30 seconds). A solution 8 made with starch and water in a relation from 70% water and 30% starch to 90% water and 10%, is added and mixed until homogenization approximately for about 90 seconds. This homogenization can be 25 seconds to three minutes, but the length of time should not be too long because even though the starch is more activated, the mixture becomes too heavy and loses fluidity such that it cannot be properly blown. Additives mentioned above could also be added in the solution in a proportion between 0.2% and 0.5% solution-based. The resulting sand mixture is blown into the core blower 36 to form the sand cores 38.

Ths starch in the forgoing solution can give better results if it is comprised of approximately 80% alpha starch and 20% native starch.

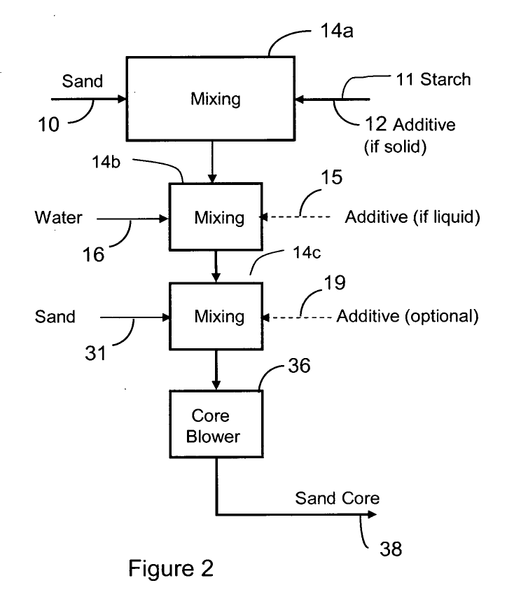

Referring to a different embodiment shown in FIG. 2, sand 10 is mixed with starch 11 as step 14a so that the sand grains are covered by starch in a proportion of about 0.5% to about 3% based on the weight of sand. The mixing time to achieve homogenization is typically about 30 seconds. At least one additive 12 from the group consisting of sodium tripolyphosphate, sodium hexamethaphosphate, dicalcium phosphate dihydrate and an alkyl silicone, triethoxy (2,4,4 trimethylpentyl) silane, octyl triethoxy silane, and an alcohol, is added with said starch if said additive is in solid form. Said additive 12 is added in a proportion not exceeding about 1% of the sand weight. Water 16 is added as step 14b in a proportion of about 5% to 15% of the sand weight. The mass is mixed with said water and optionally with one of the above additives 15 in case said additive is in liquid form for a time sufficient to achieve adequate homogenization but short of causing the mass to become hard and difficult to handle. In this step 14b, the mixing stops before a maximum of three minutes (to avoid such hardening). In mixing step 14c, more sand 31 is added, in order to adjust the flow characteristics of the coated-sand, in a proportion from about 50% to 300% based on the initial weight of sand. Optionally, an additive 19 selected from the above-mentioned group is also added during this mixing step 14c (again ceasing before the mix hardens too much for proper handling). The resulting starch-binder coated sand is blown into the core-blower 36 to form the desired sand core 38.

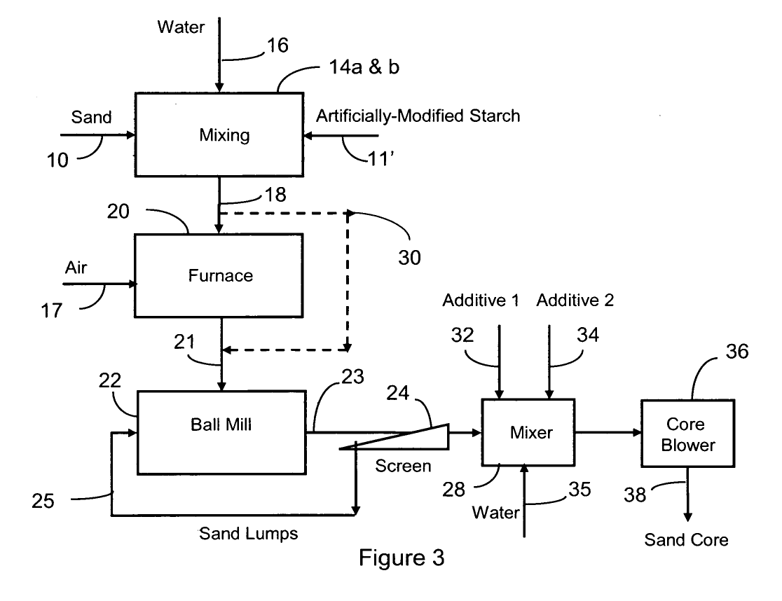

Referring now to the further embodiment shown in FIG. 3 (illustrating a diagram of modified method steps for forming such cores from artificially-modified starch); wherein, silica sand 10 is mixed with the artificially-modified starch 11′ in a proportion of from about 0.5% to 3.0% by weight on the basis of the sand weight, in a paddle mixer as step 14a for a period of time from about 30 seconds to about 120 seconds. This period of time must be sufficient for achieving a good dispersion of the starch over the surface of the sand particles. After this first mixing step 14a, water 16 is slowly added as step 14b to the sand-starch mixture, preferably in a proportion from about 5% to 10% by weight on the basis of the sand weight. The sand-starch-water mixture is mixed during step 14b for at least 1 minute, producing starch-coated sand grains 18. This coated sand 18 is then allowed to dry naturally (indicated by dotted line 30) or optionally in a suitable drying furnace 20 for accelerating the drying process and thereby increasing the process productivity. The furnace 20 can be of the type having forced air 17. The dry starch-coated sand 21 is then treated in a suitable mill 22 (for example, a ball mill or a vibrating shaker) for destroying the sand lumps which may have been formed during the previous step. Thereafter, the milled coated sand 23 is screened on a screen 24, for example utilizing a sieve # 30 for assuring that all the sand grains have a homogeneous particle size. Sand lumps 25, separated from the coated loose sand grains, are recycled to mill 22. After screening, the starch-coated sand 23 undergoes a second mixing step 28 where water 35 is added in a proportion preferably of at least 2% by weight on the basis of the sand weight. Also, sodium thipolyphosphate 32 is added in a proportion of from 0.1% to about 0.2% by weight on the basis of the sand weight, and silicon 34 from about 0.1% to 0.2% or Silres BS16 from about 0.02% to 0.08%, resulting in a wet sand mixture ready for core blowing in blower 36 where the final core 38 is formed.

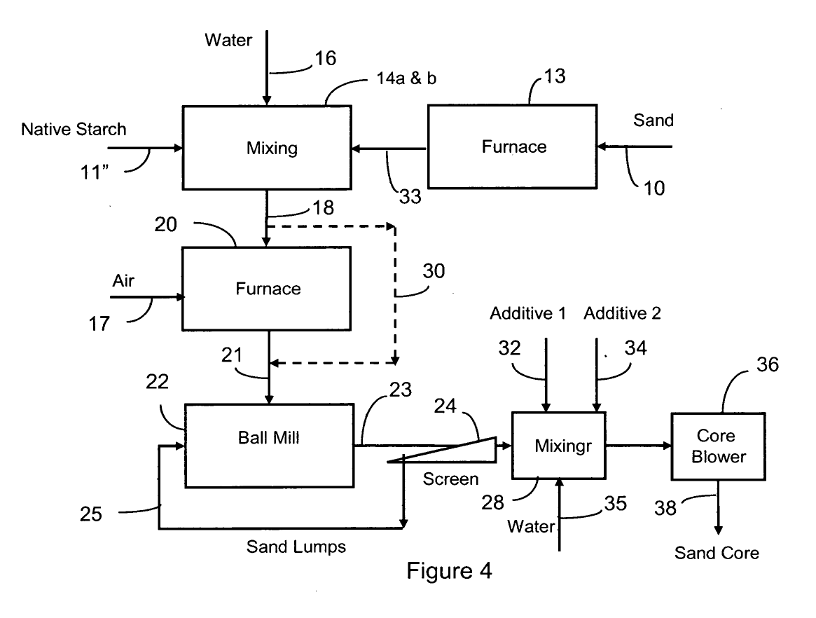

Referring now to FIG. 4, wherein same numerals designate the same elements, the method therein described is the method followed when native-type tapioca starch 11″ is used for binding the sand grains in cores and molds. Silica sand 10 is pre-heated to a temperature in the range from about 110° C. to about 130° C. in a furnace 13. The preheated sand 33 is then transferred to feed into the mixing steps 14a & b to follow the rest of the method in the same manner as above-described for the artificially modified starch 11′.

Water 16 is also preferably heated to a temperature of about 70° C. in order to preserve as much as possible the temperature of the sand above about 70° C. The amount of water 16 added at this mixing step should be sufficient to reach a humidity level in the range from about 2% to about 4% of the humid sand weight.

The rest of the method illustrated in FIG. 3 is the same as in FIG. 2.

Note that one of the main reasons of adding a water-proofing additive to the sand mixture is that sometimes formed cores have to await for several hours before being used. The water repellency additive helps the core to retain its shape without deformations. This additive is not acting on the mixture, or during the mixture fabrication process, but is intended to maintain the core conditions once the core has been blown.

The flowability additives are added to help the mixture during the blowing process.

The mechanical strength additives are added in order especially to avoid the most fragile sections of the cores from breakage.

It is of course to be understood that in the above specification, only certain specific embodiments have been included for purposes of illustrating the principles of the invention and that the invention is not intended to be limited thereto. It will also be evident that numerous changes may be made to the embodiments herein described without departing from the spirit and scope of the invention which is limited only to the extent set forth in the appended claims.

1. A method of forming sand cores and molds for foundries utilizing a starch-water-based binder comprising mixing sand grains with starch in a suitable mixer, adding water to said sand and starch mixture and continue mixing said sand, starch and water so that the sand grains are coated with starch; adding at least one additive selected from the group consisting of sodium tripolyphosphate, sodium hexamethaphosphate, dicalcium phosphate dehydratedihydrate and an alkyl silicone, triethoxitriethoxy (2,4,4 trimetilpentiltrimethylpentyl) silane, octyl triethoxitriethoxy silane, and an alcohol; and blowing said cores and molds utilizing said starch-coated sand grains.

2. The method according to claim 1, wherein said silica sand is mixed with starch in a proportion of from about 0.5% to 3% by weight on the basis of the sand weight.

3. The method according to claim 1, wherein said sand grains and starch are mixed in a paddle mixer for a period of time from about 30 seconds to about 120 seconds.

4. The method according to claim 1, wherein water is added to the sand-starch mixture in a proportion from about 5% to 10% by weight on the basis of the sand weight.

5. The method of forming sand cores and molds according to claim 1, wherein said starch-coated sand grains are allowed to dry naturally.

6. The method of forming sand cores and molds according to claim 5, wherein said starch-coated sand grains are dried in a drying furnace for increasing productivity.

7. The method of forming sand cores and molds according to claim 1, wherein the dry starch-coated sand is treated in a ball mill or a vibratory shaker.

8. The method of forming sand cores and molds according to claim 1, further comprising screening the starch-coated sand and thereafter mixing said starch-coated sand with water in a proportion of at least 2% by weight on the basis of the sand weight.

9. The method of forming sand cores and molds according to claim 1, wherein said additive is sodium tripolyphosphate, which is added in a proportion of from about 0.1% to about 0.2% by weight on the basis of the sand weight; and a further additive is silicon being also added in the same proportion.

10. The method of forming sand cores and molds according to claim 1, wherein said additive is sodium tripolyphosphate, which is added in a proportion of from about 0.1% to about 0.2% by weight on the basis of the sand weight; and a further additive is iron oxide is also added in the same proportion.

11. The method of forming sand cores and molds according to claim 1, further comprising heating said sand to a temperature in the range from about 110° C. to about 130° C. prior to mixing said sand with water and starch.

12. The method of forming sand cores and molds according to claim 1, wherein said starch is artificially modified tapioca starch.

13. The method of forming sand cores and molds according to claim 1, wherein said starch is native tapioca starch.

14. A starch-water-based binder composition suitable for forming sand cores and molds for foundries, comprising more than about 80% starch; sodium tripolyphosphate and silicon.

15. A starch-water-based binder composition suitable for forming sand cores and molds for foundries, comprising from about 0.8% to about 1.5% by weight of starch; from about 0.1% to about 0.5% by weight of sodium tripolyphosphate; and from about 0.1% to about 0.5% by weight of silicon; all on the basis of the sand weight.

16. A starch-water-based binder composition suitable for forming sand cores and molds for foundries, comprising more than about 70% of starch; from about 0.1% to about 0.5% by weight of sodium tripolyphosphate; and from about 0.1% to about 0.5% by weight of Silres BS16; all on the basis of the sand weight.

17. A starch-water-based binder composition according to claim 14, suitable for forming sand cores and molds for foundries, wherein said starch is tapioca starch.

18. A starch-water-based binder composition according to claim 14, suitable for forming sand cores and molds for foundries, wherein said starch is artificially modified tapioca starch.

19. A starch-water-based binder composition according to claim 14, suitable for forming sand cores and molds for foundries, wherein said starch is native-tapioca starch.

20. A method of forming sand cores and molds for foundries utilizing a starch-water-based binder comprising mixing starch with water in a proportion of about 10% to 30% by weight of starch, based on the mixture weight, to give an aqueous starch solution/mixture; thereafter mixing said aqueous starch solution/mixture with sand; adding to at least one of said sand and said solution/mixture, prior to their mixing, at least one additive selected from the group consisting of sodium tripolyphosphate, sodium hexamethaphosphate, dicalcium phosphate dehydratedihydrate and an alkyl silicone, triethoxitriethoxy (2,4,4 trimetilpentiltrimethylpentyl) silane, octyl triethoxitriethoxy silane, and an alcohol; and blowing said cores and molds utilizing the resulting starch-coated sand grains.
